(19) United States
(12) Patent Application Publication
(10) Pub. No.: US 2012/0153531 A1
(43) Pub. Date: Jun. 21, 2012

(54) FORMING PROCESSES USING MAGNETORHEOLOGICAL FLUID TOOLING

(75) Inventors: Kevin B. Rober, Washington, MI (US); Leonid C. Lev, West Bloomfield, MI (US); John E. Carsley, Oakland, MI (US); John C. Ulicny, Oxford, MI (US); Paul E. Krajewski, Troy, MI (US)

(73) Assignee: GM GLOBAL TECHNOLOGY OPERATIONS LLC, Detroit, MI (US)

(21) Appl. No.: 12/974,105

(22) Filed: Dec. 21, 2010

(51) Int. Cl. B29C 43/02; B29C 43/56; B29C 43/32

(52) U.S. Cl. 264/225; 264/219; 425/3

(57) ABSTRACT

A method for forming a part with a tooling assembly includes forming an MRF bladder located within the tooling assembly into a desired shape, then placing the part in the tooling assembly, and forming the part with the tooling assembly by applying pressure until the part obtains the desired shape from the MRF bladder.

### TECHNICAL FIELD

The present invention relates to tooling assemblies for sheet and tube forming processes.

### BACKGROUND

Tooling assemblies for sheet forming processes may use flexible dies to form a part into a desired shape. Flexible die forming may employ a rubber pad as one portion of the tooling assembly and a solid form for the other portion of the tooling assembly. Flexible die tooling provides the advantage of only requiring a part of the die to have a solid form which decreases processing time and cost it may also increase formability. However, the rubber pad may slightly deform due to the pressure applied during the forming process. In particular, any contours on the rubber pad flatten during the forming stroke, which makes sharp angles difficult to form. This results in flexible die tooling typically being available only to form shallow parts with simple configurations.

### SUMMARY

A tooling assembly for forming a part is proposed which includes a die which at least partially forms a die cavity, a punch located proximate to the die and moveable toward the die cavity, and a magnetorheological fluid (MRF) bladder located within the die cavity capable of being formed into a desired shape for forming the part.

A method of forming an MRF bladder for use with a tooling assembly includes placing a template in a cavity defined by the tooling assembly. The MRF bladder is located within the cavity and is filled with a MRF in an inactivated state. Pressure is applied with the tooling to form the MRF bladder into the desired shape of the template. A stimulus is applied to the MRF bladder to activate the MRF located within the MRF bladder to maintain the desired shape.

A method for forming a part with the tooling assembly includes forming the MRF bladder located within the tooling assembly into a desired shape, then placing the part in the tooling assembly, and forming the part with the tooling assembly by applying pressure until the part obtains the desired shape from the MRF bladder.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional illustration of a first embodiment of a tooling assembly having a MRF bladder, showing a first step of a forming process;

FIG. 2 is a schematic cross-sectional illustration of a first embodiment of a tooling assembly having a MRF bladder, showing a second step of the forming process;

FIG. 3 is a schematic cross-sectional illustration of a first embodiment of a tooling assembly having a MRF bladder, showing a third step of the forming process;

FIG. 4 is a schematic cross-sectional illustration of a first embodiment of a tooling assembly having a MRF bladder, showing a fourth step of a forming process;

FIG. 5 is a schematic cross-sectional illustration of a first embodiment of a tooling assembly having a MRF bladder, showing a fifth step of a forming process;

FIG. 6 is a schematic cross-sectional illustration of a second embodiment of a tooling assembly having a MRF bladder, showing the fifth step of a forming process;

FIG. 7 is a schematic cross-sectional illustration of a third embodiment of a tooling assembly having a MRF bladder, showing the fifth step of a forming process;

FIG. 8 is a schematic cross-sectional illustration of a fourth embodiment of a tooling assembly having a MRF bladder, showing the fifth step of a forming process; and

FIG. 9 is a schematic cross-sectional illustration of a fifth embodiment of a tooling assembly having a MRF bladder, showing the fifth step of a forming process.

### DETAILED DESCRIPTION

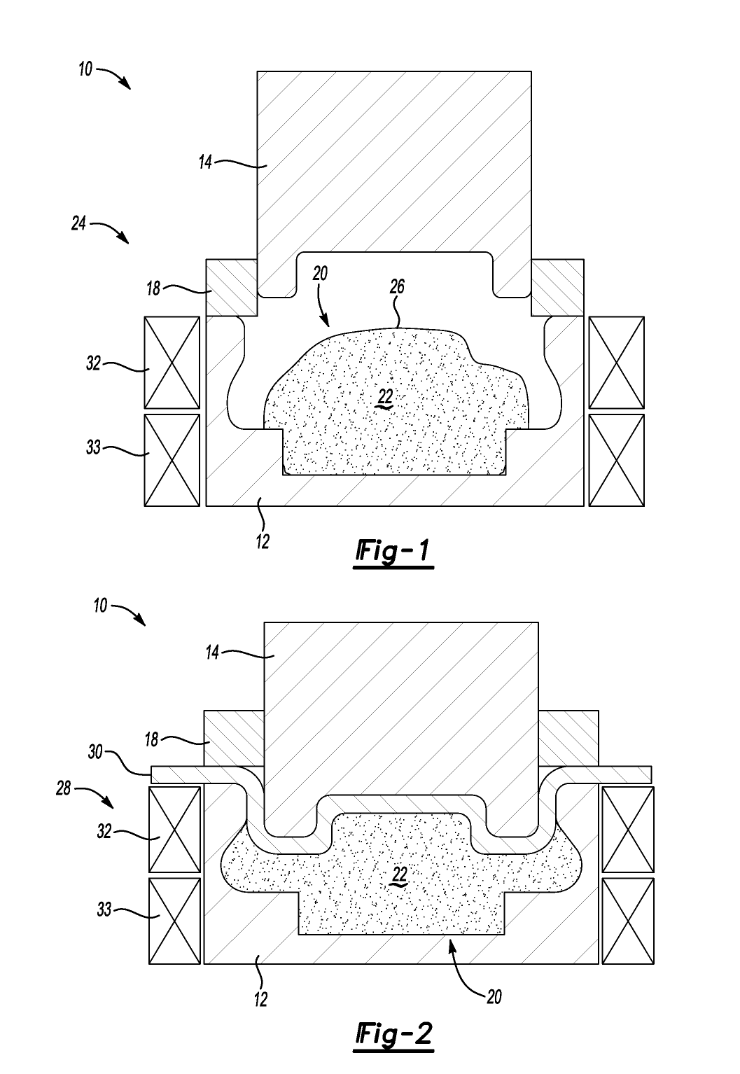

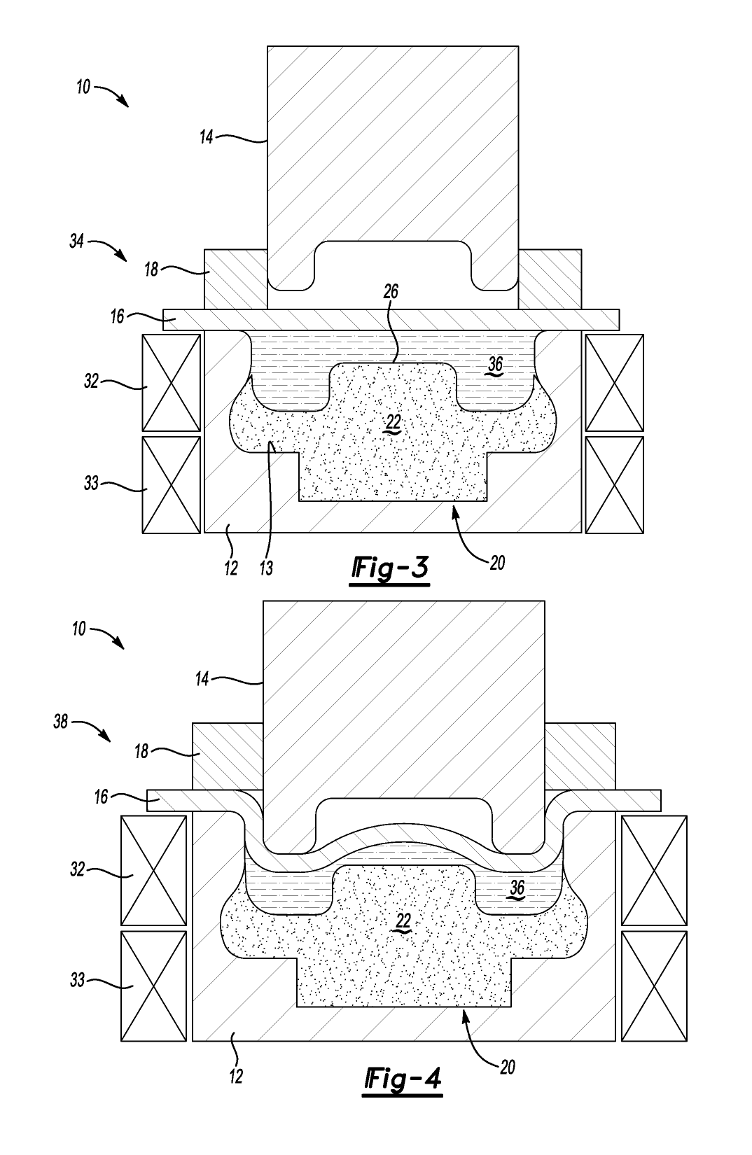

Referring to the drawings wherein like reference numbers correspond to like or similar components throughout the several figures, and beginning with FIGS. 1-5, a tooling assembly 10 includes a lower die 12 and a punch 14 for forming a part 16 (shown in FIGS. 3-5). A binder ring 18 may also be used to help retain the part 16 and guide the punch 14 during the forming process. The tooling assembly 10 includes a magnetorheological fluid (MRF) bladder 20 filled with a MRF 22 located in a cavity 13 that is at least partially formed by the lower die 12. FIG. 1 illustrates a first step 24 in the forming process where the MRF bladder 20 is shown having the MRF 22 in an inactivated state. The MRF bladder 20 is formed from a flexible material 26 which is filled with MRF 22 in the form of liquid, foam, or gel. When the MRF 22 is in the form of gel the flexible material 26 may not be required.

FIG. 2 illustrates a second step 28 of the tooling process during the forming of the MRF bladder 20. The MRF bladder 20 is arranged into a desired shape which is required to make the part 16. A template 30 is inserted into the tooling assembly 10. The template 30 has the desired shape of the part 16. The template 30 may be a part 16 that has already been formed, or may be another material that is formed into the desired shape of the part 16. The punch 14 is lowered to apply pressure on the template 30 and MRF bladder 20 until the template 30 moves the MRF bladder 20 into the desired shape. Once the MRF bladder 20 has attained the desired shape the MRF 22 is activated. The MRF 22 may be activated by applying a stimulus, such as by utilizing a magnetic coil 32 to apply a magnetic flux to the MRF 22 to change the modulus of the MRF 22. The stimulus is continuously applied to maintain the MRF bladder 20 in the desired shape. The punch 14 may than be raised and the template 30 may be removed.

FIG. 3 illustrates a third step 34 in the forming process. An unformed part 16 is placed in the tooling assembly 10. A cavity 36 may be defined between the part 16 and the MRF bladder 20. The cavity 36 may be filled with fluid, such as water, such that the tooling process is a hydroforming process. However, it is not necessary for cavity 36 to be filled, such as during a stamping process.

FIG. 4 illustrates a fourth step 38 in the forming process. The punch 14 is moved toward the lower die 12. The stimulus is continuing to hold the MRF bladder 20 in the desired shape. Therefore, the bladder 20 forms the part 16 into the desired shape as pressure is applied. In the case where the forming process is a hydroforming process, there may be a proportional relief valve (not shown) to release the fluid within the cavity 36 and control the pressure acting on the part 16. The pressure relief provided by the proportional relief valve may be a function of the punch 14 stroke.

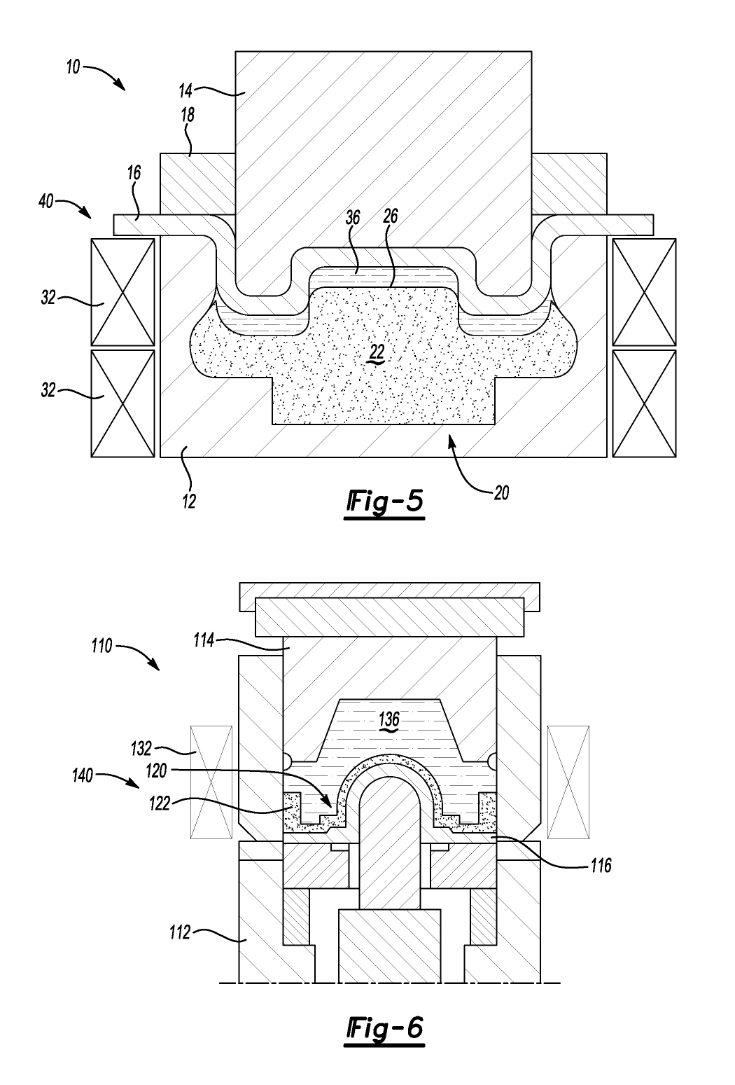

FIG. 5 illustrates a fifth step 40 for forming the part 16. The part 16 is formed into the desired shape. The punch 14 is raised and the formed part 16 is removed from the tooling assembly 10. Additional parts 16 may be formed by repeating the third, fourth and fifth steps 34, 38 and 40, illustrated in FIGS. 3-5, as many times as required.

Once the desired number of parts 16 have been created, the stimulus, i.e. the magnetic flux being applied by the magnetic coil 32, may be removed. The MRF fluid 22 is inactivated and the MRF bladder 20 is restored to the unformed shape, illustrated in FIG. 1. Other parts 16 having different shapes than that shown may be formed by repeating the first through fifth steps 24, 28, 34, 38 and 40. The template 30 may be selected to form the MRF bladder 20 into a desired shape for each differently shaped part 16. In this manner, the tooling assembly 10 may be used to form many differently shaped parts 16. Reforming the MRF bladder 20 into the desired shape may be done quickly and economically. Thus, a relatively small number of parts 16 may be formed without requiring expensive tooling dies to create the desired form.

In the embodiments shown in FIGS. 1-5, a first and second magnetic coil 32, 33 are used to apply stimulus to the MRF 22. However, one or more magnetic coils 32, 33 may be utilized to allow for variation in the magnetic flux to different areas of the MRF 22. The magnetic flux applied by the magnetic coils 32, 33 may vary from one area of the MRF bladder 20 to another area of the MRF bladder 20. Alternatively, the magnetic flux applied by the magnetic coils 32, 33 may also vary at one location during the forming process. The magnetic coils 32, 33 may be located proximate to the MRF bladder 20 and may be positioned to direct the magnetic flux toward certain areas of the MRF bladder 20. The position on the magnetic coils 32, 33 may be adjustable to assist in varying the magnetic flux to the different areas of the MRF 22 as is required for a particular part 16. In this manner the MRF bladder 20 may be tuned for a selected part 16 allowing better control of material flow while forming a specific part 16. Additionally, the MRF bladder 20 may be heated to assist in controlling the material flow during the forming of the part 16. Tuning the MRF bladder 20 for a specific part 16 provides for more uniform strain distribution over the part 16, which in turn allows for sharper radii to be formed. One skilled in the art would be able to determine the desired variation of magnetic flux applied to the MRF 22 depending on the shape of the part 16 being formed.

Therefore, FIGS. 1-5 illustrate a method of forming a MRF bladder 20 for use with a tooling assembly 10 that includes placing a template 30 in the tooling assembly 10, wherein the MRF bladder 20 is located within the cavity 13 of the tooling assembly 10. The MRF bladder 20 is filled with a magnetorheological fluid 22 in an inactivated state. Pressure is applied with the tooling assembly 10 to form the MRF bladder 20 into the desired shape of the template 30. A stimulus is applied to the MRF bladder 20 to activate the MRF 22 located within the MRF bladder 20 to maintain the desired shape. Further, FIGS. 1-5 illustrate a method for forming a part 16 with the tooling assembly 10 including forming the MRF bladder 20 located within the tooling assembly 10 into a desired shape, then placing the part 16 in the tooling assembly 10, and forming the part 16 with the tooling assembly 10 by applying pressure until the part 16 obtains the desired shape from the MRF bladder 20.

Referring to FIG. 6, a second embodiment of a tooling assembly 110 utilizing an MRF bladder 120 to form a part 116 is illustrated. The tooling assembly 110 is illustrated at the fifth step 140 of the forming process. The part 116 is supported on the lower die 112 and the MRF bladder 120 is located above the part 116 to act as the upper die. The MRF bladder 120 has been formed into the desired shape similar to the process described above. The magnetic coils 132 are applying a magnetic flux to the MRF 122 to maintain the MRF bladder 120 in the desired shape. The punch 114 applies pressure to the fluid within the cavity 136 which presses down on the MRF bladder 120 to form the part 116 into the desired shape. The lower die 112 may include a predetermined desired shape.

Additionally, the MRF bladder 120 may be used to provide adjustable stiffness for forming the part 116. In this manner, the MRF bladder 120 may be used to assist in controlling the flow of material as the part 116 is pressed in to shape. Controlling the flow of material provides the part 116 with a more uniform thickness and reduces the tension created at typical stress points on the shaped part 116. In the embodiment shown, the thickness of the MRF bladder 120 is reduced and smaller magnetic coils 132 and more finely adjustable tuning of the MRF bladder 120 may be achieved for controlling the material flow.

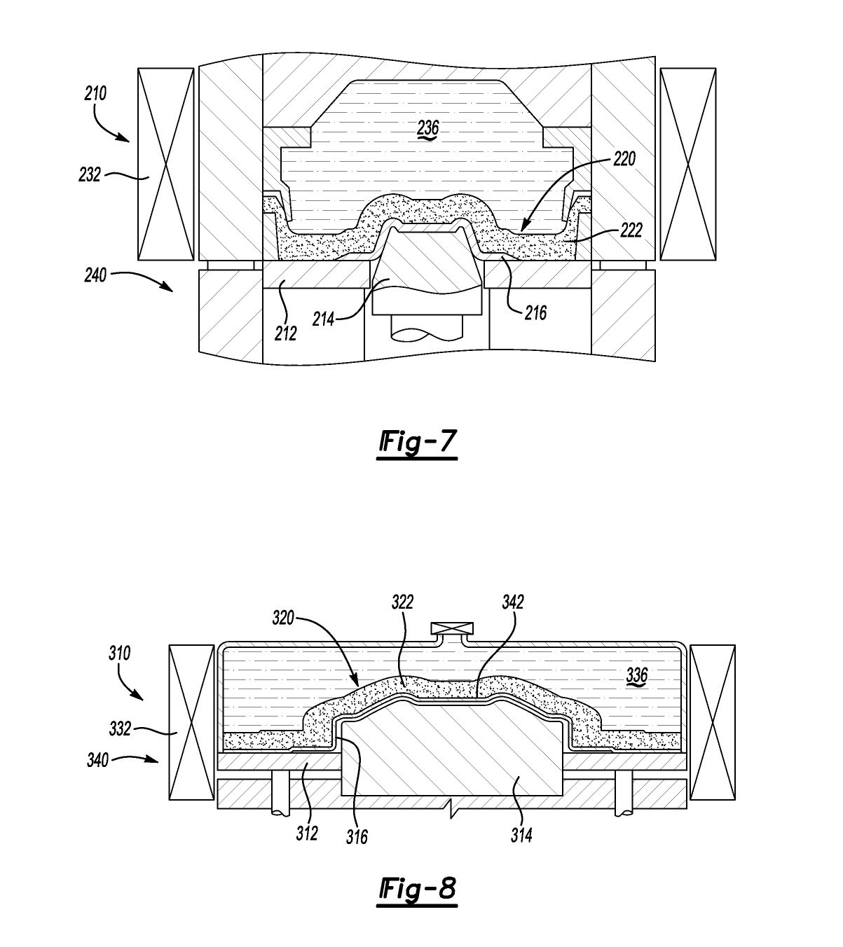

Referring to FIG. 7, a third embodiment of a tooling assembly 210 utilizing an MRF bladder 220 to form a part 216 is illustrated. The tooling assembly 210 is illustrated at the fifth step 240 of the forming process. The part 216 is supported on the lower die 212 and the MRF bladder 220 is located above the part 216 to act as the upper die 212. The MRF bladder 220 has been formed into the desired shape similar to the process described above. The magnetic coils 232 are applying a magnetic flux to the MRF 222 to maintain the MRF bladder 220 in the desired shape. Fluid in cavity 236 defined by the tooling assembly 210 applies pressure to the MRF bladder 220 which presses down to form the part 216 into the desired shape. The lower die 212 may include a punch 214 having predetermined desired shape.

Additionally, the MRF bladder 220 may be used to provide adjustable stiffness for forming the part 216. In this manner, the MRF bladder 220 may be used to assist in controlling the flow of material as the part 216 is pressed in to shape. Controlling the flow of material provides the part 216 with a more uniform thickness and reduces the tension created at typical stress points on the shaped part 216. In the embodiment shown, the thickness of the MRF bladder 220 is reduced and smaller magnetic coil 232 and more finely adjustable tuning of the MRF bladder 220 may be achieved for controlling the material flow.

The lower die 212 and the MRF bladder 220, extend past the part 216, such that the lower dies 212 and the MRF bladder 220 shape the ends of the part 216. Additionally, a punch 214 of the lower die 212 may be changed out and the MRF bladder 220 may be reshaped in a similar manner as described above such that different types of part 216 may be formed by the tooling assembly 210. The fluid in the cavity 236 allows pressure to be applied to the part while accommodating the change of the shape of the MRF bladder 220 for a particular part 216.

Referring to FIG. 8, a fourth embodiment of a tooling assembly 310 utilizing an MRF bladder 320 to form a part 316 is illustrated. The tooling assembly 310 is illustrated at the fifth step 340 of the forming process. The part 316 is supported on the lower die 312 and the MRF bladder 320 is located above the part 316 to act as the upper die. The MRF bladder 320 has been formed into the desired shape similar to the process described above. The magnetic coils 332 are applying a magnetic flux to the MRF 322 to maintain the MRF bladder 320 in the desired shape. Fluid is located in a cavity 336 defined by the tooling assembly 310. The fluid applies pressure to the MRF bladder 320 which presses down on to form the part 316 into the desired shape. The lower die 312 may include a punch 314 having predetermined desired shape.

Additionally, the MRF bladder 320 may be used to provide adjustable stiffness for forming the part 316. In this manner, the MRF bladder 320 may be used to assist in controlling the flow of material as the part 316 is pressed into shape. Controlling the flow of material provides the part 316 with a more uniform thickness and reduces the tension created at typical stress points on the shaped part 316. In the embodiment shown, the thickness of the MRF bladder 320 is reduced and smaller magnetic coil 332 and more finely adjustable tuning of the MRF bladder 320 may be achieved for controlling the material flow.

A wear pad 342 is located between the MRF bladder 320 and the part 316. The wear pad 342 assists in protecting the MRF bladder 320 while shaping the part 316. The wear pad 342 also provides little to no effect on the flow of material as the part 316 is pressed into shape. Therefore, the material flow may still be controlled by the MRF bladder 320.

Additionally, a punch 314 of the lower die 312 may be changed out and the MRF bladder 320 may be reshaped in a similar manner as described above such that different types of part 316 may be formed by the tooling assembly 310.

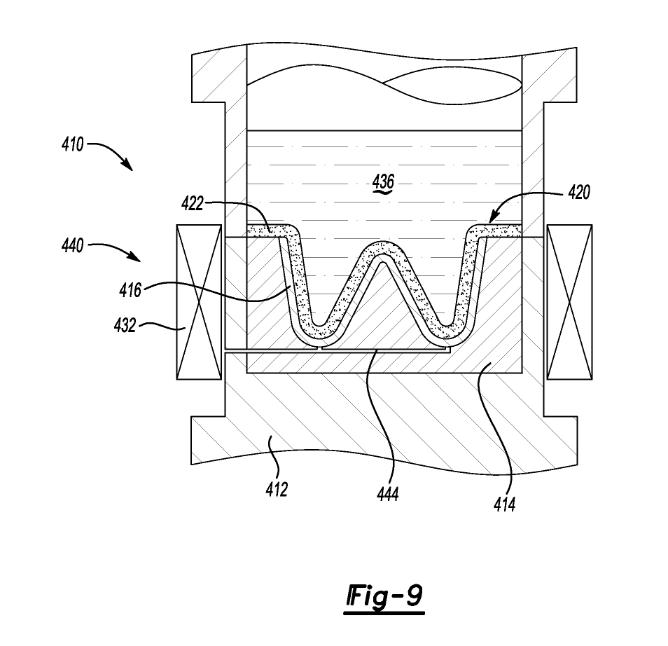

Referring to FIG. 9, a fifth embodiment of a tooling assembly 410 utilizing an MRF bladder 420 to form a part 416 is illustrated. The tooling assembly 410 is illustrated at the fifth step 440 of the forming process. The part 416 is supported on the lower die 412 and the MRF bladder 420 is located above the part 416 to apply pressure to the part 416. The MRF bladder 420 has been formed into the desired shape similar to the process described above. The magnetic coils 432 are applying a magnetic flux to the MRF 422 to maintain the MRF bladder 420 in the desired shape. Fluid is located in a cavity 436 defined by the tooling assembly 410. The fluid applies pressure to the MRF bladder 420 which presses down to form the part 416 into the desired shape. The lower die 412 may include a punch 414 having a predetermined desired shape and the MRF bladder 420 may be used to provide adjustable stiffness for forming the part 416. In this manner, the MRF bladder 420 may be used to assist in controlling the flow of material as the part 416 is pressed into shape. Controlling the flow of material provides the part 416 with a more uniform thickness and reduces the tension created at typical stress points on the shaped part 416. Air vents 444 located in the punch 414 and lower dies 412 allow air trapped between the part 416 and the punch 414 to escape as the part is pressed against the punch 414. Additionally, as the thickness of the MRF bladder 420 is reduced and smaller magnetic coil 432 and more finely adjustable tuning of the MRF bladder 420 may be achieved for controlling the material flow.

The punch 414 of the lower die 412 may be changed out and the MRF bladder 420 may be reshaped in a similar manner as described above such that different types of part 416 may be formed by the tooling assembly 410.

While the best modes for carrying out the invention have been described in detail, those familiar with the art to which this invention relates will recognize various alternative designs and embodiments for practicing the invention within the scope of the appended claims.

1. A method for forming a part with a tooling assembly comprising:
forming a magnetorheological fluid bladder located within the tooling assembly into a desired shape;
placing the part in the tooling assembly; and
forming the part with the tooling assembly by applying pressure until the part obtains the desired shape from the magnetorheological fluid bladder.

2. The method of claim 1, wherein forming the magnetorheological fluid bladder further comprises:
placing a template in the tooling assembly;
applying pressure to the template to form the magnetorheological fluid bladder into the desired shape; and
applying a stimulus to the magnetorheological fluid bladder to activate magnetorheological fluid located within the magnetorheological fluid bladder to maintain the desired shape.

3. The method of claim 2, further comprising removing the stimulus to inactivate the magnetorheological fluid located within the magnetorheological fluid bladder.

4. The method of claim 2, wherein applying the stimulus further comprises applying different amounts of stimulus to different areas of the magnetorheological fluid to provide different stiffnesses in the respective different areas of the magnetorheological fluid bladder.

5. The method of claim 2, further comprising positioning a magnetic coil proximate to the magnetorheological fluid bladder in a position to apply the stimulus in a desired direction toward the magnetorheological fluid.

6. The method of claim 1, further comprising repeating the placing of the part in the tooling assembly and forming the part.

7. The method of claim 1, wherein forming the part further comprises varying a stiffness of the magnetorheological fluid in at least a first location to assist in controlling flow of the material during forming of the part.

8. A method of forming a magnetorheological fluid bladder for use with a tooling assembly comprising:
placing a template in a cavity defined by the tooling assembly, wherein the magnetorheological fluid bladder is located within the cavity and is filled with a magnetorheological fluid in an inactivated state;
applying pressure with the tooling assembly to form the magnetorheological fluid bladder into the desired shape of the template; and
applying a stimulus to the magnetorheological fluid bladder to activate the magnetorheological fluid located within the magnetorheological fluid bladder to maintain the desired shape.

9. The method of claim 8, wherein applying the stimulus further comprises applying different amounts of stimulus to different areas of the magnetorheological fluid to provide different stiffnesses in the respective different areas of the magnetorheological fluid bladder.

10. The method of claim 9, wherein applying the different amounts of stimulus further comprises applying at least a first stimulus with a first magnetic coil and applying a second stimulus with a second magnetic coil.

11. The method of claim 8, further comprising positioning a magnetic coil proximate to the magnetorheological fluid bladder in a position to apply the stimulus in a desired direction toward the magnetorheological fluid.

12. The method of claim 8, further comprising removing the stimulus to inactivate the magnetorheological fluid located within the magnetorheological fluid bladder.

13. The method of claim 8, further comprising repeating the steps of placing a template in the cavity of the tooling assembly, applying pressure with the tooling assembly, and applying a stimulus to the magnetorheological fluid bladder with another template having a different desired shape than the first template.

14. A tooling assembly for forming a part comprising:
a die at least partially forming a die cavity;
a punch located proximate to the die and moveable toward the die cavity; and
a magnetorheological fluid bladder located within the die cavity operable to be formed into a desired shape for forming the part.

15. The tooling assembly of claim 14, wherein a magnetorheological fluid is located within the magnetorheological fluid bladder, wherein the magnetorheological fluid is operable to have an increased stiffness when a stimulus is applied thereto, and wherein the increased stiffness is operable to maintain the magnetorheological fluid in a shape while the stimulus is applied.

16. The tooling assembly of claim 14, further comprising at least one magnetic coil located proximate to the magnetorheological fluid bladder to apply a stimulus to the magnetorheological fluid.
